(19) United States
(12) Patent Application Publication
(10) Pub. No.: US 2025/0119019 A1
(43) Pub. Date: Apr. 10, 2025

(54) SEMI-FINISHED PRODUCT FOR PRODUCING A SLOT INSULATION ELEMENT, SLOT INSULATION ELEMENT, AND STATOR FOR AN ELECTRICAL MACHINE WITH A SLOT INSULATION ELEMENT

(71) Applicant: Schaeffler Technologies AG & Co. KG, Herzogenaurach (DE)

(72) Inventor: Florian Sell-Le Blanc, Karlsruhe (DE)

(73) Assignee: Schaeffler Technologies AG & Co. KG, Herzogenaurach (DE)

(21) Appl. No.: 18/730,306

(22) PCT Filed: Dec. 12, 2022
(86) PCT No.: PCT/DE2022/100940

§ 371 Date: Jul. 19, 2024

(30) Foreign Application Priority Data
Jan. 25, 2022 (DE) 10 2022 101 637.4

(51) Int. Cl. H02K 3/34

(52) U.S. Cl. CPC H02K 3/345

(57) ABSTRACT

A semi-finished product, in particular a blank, for producing a slot insulation element is disclosed. The blank is manufactured from a flat, electrically insulating material, and includes a rectangular slot section adapted to be disposed in a slot of a stator of an electrical machine. A first coil end section is disposed in a longitudinal direction adjacent to the slot section and adapted to be disposed outside of the slot in the region of a coil end of the electrical machine. The semi-finished product being characterised in that the first coil end section has a greater width than the slot section in a width direction perpendicular to the longitudinal direction.

### CROSS-REFERENCE TO RELATED APPLICATIONS

This application is the U.S. National Phase of PCT Appln. No. PCT/DE2022/100940 filed Dec. 12, 2022, which claims priority to DE 10 2022 101 637.4 filed Jan. 25, 2022, the entire disclosures of which are incorporated by reference herein.

### TECHNICAL FIELD

The disclosure relates to a semi-finished product, in particular a blank, for producing a slot insulation element. The disclosure further relates to a slot insulation element. The disclosure also relates to an electrical machine having a slot insulation element.

### BACKGROUND

A stator of an electrical machine comprising a wave coil typically has slots running in the axial direction of the stator, into which coil conductors are guided. At the front sides of the stator, the coil conductors exit the stator, pass through a curved or angled region and enter another slot in the stator. The coil conductors protruding and bent outside the stator on its front side form a so-called coil end of the electrical machine. In electrical machines with a rotor coil, for example separate-excited synchronous machines, a corresponding coil end is created on the front sides of the rotor.

For electrical insulation, slot insulation elements made of an electrically insulating material are usually inserted into the slots. For example, the slot insulation elements can be made of paper. These slot insulation elements protrude from the slot on the front side of the stator over the axial length of the slot in order to provide electrical clearance and creepage distances for insulation. In order to prevent unwanted damage to the slot insulation elements, the coil conductors in the region of this projection of the slot insulation elements are generally designed with a straight course. The curvature or bending of the coil conductors can therefore only take place from a distance from the front side which is determined by the projection of the slot insulation element or the clearance and creepage distances. In this respect, the compact design of the coil end is limited by the projection of the slot insulation elements.

In the prior art, it is also known to treat slot insulation elements disposed in a slot in the region of their projection using thermal processes in order to enable a curvature or bending of the coil conductors already in the region of the projection. This creates mechanical stresses that can lead to material failure of the slot insulation element and thus a drastic reduction in the insulation properties.

### SUMMARY

Against this background, the object is to enable the coil end of an electrical machine to be designed as compactly as possible without having to accept any loss in terms of the insulation properties of the slot insulation elements.

The objective is achieved by a semi-finished product, in particular a blank, for producing a slot insulation element, wherein the semi-finished product is manufactured from a flat, electrically insulating material, comprises a rectangular slot section adapted to be disposed in a slot of a stator of an electrical machine, and comprises a first coil end section disposed in a longitudinal direction adjacent to the slot section and adapted to be disposed outside of the slot in the region of a coil end of the electrical machine, wherein the first coil end section has a greater width than the slot section in a width direction perpendicular to the longitudinal direction.

Because the coil end section of the semi-finished product is wider than the slot section of the semi-finished product, a slot insulation element can be formed from the semi-finished product which has a cross-section that widens outside of the slot. Due to this cross-section of the slot insulation element, which is wider than the slot, it is possible to already provide the coil conductors with a curvature in the region outside of the slot in which the coil conductors are provided with the slot insulation element, without having to fear undesirable tearing or a deviation from the shape accuracy of the slot insulation element. In this respect, the coil conductors can be guided out of the slot with a greater curvature, i.e. with a smaller radius of curvature, and/or the distance between the exit of the coil conductors from the slot and the beginning of their curvature can be reduced. Consequently, the coil end of the electrical machine can be made more compact. Unlike in the prior art, thermal treatment of the slot insulation elements is not necessary when using the semi-finished product according to the disclosure, so that the risk of material failure of the slot insulation element is reduced.

Preferably, the semi-finished product is a blank. The blank may be provided by punching or cutting a layer of the flat, electrically insulating material. Alternatively, it may be provided that the semi-finished product is provided by connecting several elements of the flat, electrically insulating material.

Preferably, the flat, electrically insulating material is paper. Alternatively, the flat, electrically insulating material can be a foil or a textile.

According to an advantageous embodiment of the disclosure, it is provided that the semi-finished product comprises a second coil end section disposed in a longitudinal direction adjacent to the slot section and adapted to be disposed outside of the slot in the region of a coil end of the electrical machine, wherein the second coil end section has a greater width than the slot section in a width direction perpendicular to the longitudinal direction and wherein the first and second coil end sections are disposed on opposite sides of the slot section. By providing a first and a second coil end section, it is possible to form a slot insulation element which has a cross-section which widens on two opposite front sides of the slot or the stator. In this respect, the coil ends of the electrical machine can be formed compactly on both front sides of the stator. Preferably, the first and second coil end sections of the semi-finished product are mirror-symmetrically identical. Such an embodiment offers the advantage that the slot insulation element formed from the semi-finished product has an identical widening of its cross-section on both sides.

An advantageous embodiment of the disclosure provides that the first and/or second coil end section comprises fold lines which are disposed to run obliquely to the longitudinal direction. The fold lines running obliquely to the longitudinal direction can be used to define a plurality of side portions of the coil end section. For example, by providing exactly two fold lines running obliquely to the longitudinal direction, it is possible to define exactly three side portions of the coil end section. Such a coil end section can have a U-shaped cross-section, i.e. it can cover three sides of a coil conductor. Furthermore, by providing exactly four fold lines running obliquely to the longitudinal direction, it is possible to define exactly five side portions of the coil end section. Thus, either a five-sided cross-section can be formed or two side portions can be disposed in an overlapping manner to form a circumferential four-sided cross-section (O-shape).

An advantageous embodiment of the disclosure provides that the first and/or second coil end section has a central portion and two side portions adjacent to the central portion, which are each separated from the central portion by an inner fold line disposed to run obliquely to the longitudinal direction. By such an embodiment of the semi-finished product, a slot insulation element can be obtained which has a U-shaped cross-section at least in the region protruding from the slot. Preferably, the slot section of the semi-finished product comprises a central slot portion and two side slot portions adjacent to the central slot portion, each of which is separated from the central slot portion by an inner slot fold line disposed to run parallel to the longitudinal direction. By such an embodiment of the semi-finished product, a slot insulation element can be obtained which also has a U-shaped cross-section in the slot section. Preferably, the inner slot fold lines of the slot section merge into the inner fold lines of the coil end section.

A particularly advantageous embodiment of the disclosure additionally provides that the first and/or second coil end section has two outer portions, each adjacent to one of the side portions, which are each separated from the respective side portion by an outer fold line disposed to run obliquely to the longitudinal direction. By such an embodiment of the semi-finished product, a slot insulation element can be obtained which has an O-shaped cross-section at least in the region protruding from the slot. Preferably, the slot section of the semi-finished product comprises two outer slot portions, each adjacent to one of the side slot portions, which are each separated from the respective side slot portion by an outer slot fold line disposed to run parallel to the longitudinal direction. By such an embodiment of the semi-finished product, a slot insulation element can be obtained which also has an O-shaped cross-section in the slot section. Preferably, the outer slot fold lines of the slot section merge into the outer fold lines of the coil end section.

In this context, it has proven advantageous if the inner and outer fold lines are disposed to be parallel. This makes it possible to obtain side portions with a constant width.

An advantageous embodiment of the disclosure provides that the width of the first and/or second coil end section increases to a point of maximum width starting from a transition to the slot section along the longitudinal direction. By such an increase in the width of the respective coil end section of the semi-finished product, a funnel-shaped portion can be obtained in the slot insulation element produced from the semi-finished product. This funnel-shaped portion may protrude from the front side of the stator in a state in which the slot insulation element is disposed in the stator. The funnel-shaped embodiment allows a curved embodiment of the coil conductors directly after exiting the slot of the stator. Preferably, the width of the first and/or second coil end section increases linearly along the longitudinal direction. Alternatively, the increase in width can be non-linear, for example quadratic.

In this context, an advantageous embodiment of the disclosure provides that the width of the first and/or second coil end section decreases starting from the point of maximum width along the longitudinal direction.

To achieve the aforementioned objective, a slot insulation element for a stator of an electrical machine is also proposed, which is produced from a semi-finished product described above.

The same advantages can be achieved by the slot insulation element as have already been described in connection with the semi-finished product. In particular, the slot insulation element can be formed from the semi-finished product solely by folding or creasing. Thermal treatment is not required to form the slot insulation element.

According to an advantageous embodiment of the slot insulation element according to the disclosure, it is provided that the outer portions of the semi-finished product are disposed such that they overlap. By such an arrangement, a slot insulation element with an O-shaped cross-section can be obtained.

A further subject matter of the disclosure is an electrical machine comprising a plurality of slots, in particular stator slots or rotor slots, wherein a slot insulation element as described above is disposed in each of the slots.

The same advantages can be achieved with the electrical machine as already explained in connection with the blank.

In a method for mounting the slot insulation element in a slot of an electrical machine, the slot insulation element is formed from the semi-finished product, in particular by folding or creasing along the fold lines, and disposed in the slot.

In the method, the slot insulation element can be disposed with a radial projection in the slot, for example by a movement in the axial direction of the slot. In a further process step, the final contour of the slot insulation element can be achieved using a shaping tool or element. Alternatively, it is possible to dispose the slot insulation element in a magazine and form the final contour. The slot insulation element can then be introduced into the slot, in particular by a movement in the radial direction of the slot.

For the application of this disclosure for coils of rotors and stators with non-circular conductor profiles, an advantageous embodiment is the formation of the final contour of the slot insulation element before the actual coil assembly for radial joining processes, e.g. for wave coils. For axial joining processes, e.g. for hairpin coils, the final contour of the slot insulation element can be formed together with the assembly of the coil conductors in the slot.

The application of this disclosure for coils of rotors and stators with round conductor profiles is usually carried out with prior formation of the final contour of the slot insulation element.

In the case of the slot insulation element and the electrical machine, the advantageous embodiments and features described in connection with the blank can be used alone or in combination.

In order to comply with the clearance and creepage distances mentioned above, it may be advantageous not to select a minimal projection of the slot insulation element on the front side of the slot. As a result, the length of the slot insulation element can be increased in the axial direction compared to a slot insulation according to the prior art, since the larger width of the slot insulation element or its funnel shape requires an additional length of material in order to achieve the same axial projection as in the prior art.

In particular with regard to maintaining the clearance and creepage distances for the air gap of the rotor or stator slot, it may be useful to provide additional insulation elements, such as cover slides or slot closure wedges. The shape of these insulation elements in the slot is preferably adapted to the final contour of the slot insulation element. This can be realized in an advantageous embodiment of the disclosure with two conical shapes in the region of the coil ends. Alternatively, the installation of multi-part cover slides is a technical alternative to avoid possible damage to the clearance and creepage distance.

### BRIEF DESCRIPTION OF THE DRAWINGS

Further details and advantages of the disclosure will be explained below with reference to the exemplary embodiment shown in the drawings. In the drawings:

FIG. 1 shows a coil conductor emerging from a slot of a stator according to the prior art in a schematic side view;

FIG. 2 shows a coil conductor emerging from a slot of a stator with a slot insulation element according to an embodiment of the disclosure in a schematic side view;

FIG. 3 shows a first exemplary embodiment of a semi-finished product for a slot insulation element according to the disclosure in a plan view;

FIG. 4 shows a slot of a stator with a slot insulation element which is formed from the semi-finished product according to FIG. 3 in a top view of the slot from one front side of the stator;

FIG. 5 shows the slot according to FIG. 4 in a top view of the slot from an inner diameter of the stator;

FIG. 6 shows a second exemplary embodiment of a semi-finished product for a slot insulation element according to the disclosure in a plan view;

FIG. 7 shows a slot of a stator with a slot insulation element which is formed from the semi-finished product according to FIG. 6 in a top view of the slot from one front side of the stator;

FIG. 8 shows the slot according to FIG. 7 in a top view of the slot from an inner diameter of the stator;

### DETAILED DESCRIPTION

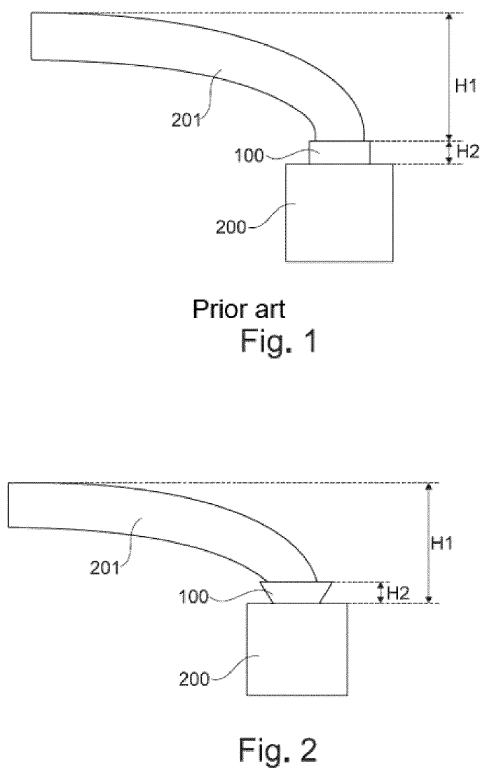

In FIG. 1, a schematic side view shows a coil conductor 201 emerging from a slot of a stator 200 according to the prior art. A conventional slot insulation element 100 according to the prior art is disposed in the slot. The slot insulation element 100 projects from the slot on the front side of the stator 200. The corresponding projection is designated by the reference symbol H2 in FIG. 1. The coil conductor 201 has a straight course in the region of this projection H2 of the slot insulation element 100, i.e. it projects substantially perpendicularly from the slot of the stator 200. A curvature or bending of the coil conductor 201 only begins in a region that is at a greater distance from the front side than the projection H2 of the slot insulation element 100. The height H1 of the bent coil conductor 201 or the coil end is added to the projection H2 of the slot insulation element. Overall, this results in an embodiment of the electrical machine in which the coil end projects by the sum of the height of the coil conductor H1 and the projection from the front side of the stator.

The representation in FIG. 2 shows a stator 200 for an electrical machine having one of a plurality of stator slots, wherein a slot insulation element 100 according to an exemplary embodiment of the disclosure is disposed in the stator slot. This results in a more compact design compared to FIG. 1, since the bending of the coil conductor 201 can already begin at the point where it exits the slot of the stator 200. The slot insulation element 100 is made from a semi-finished product 1 designed as a blank according to an embodiment of the disclosure. In the following, a plurality of embodiments of such semi-finished products 1 will be explained.

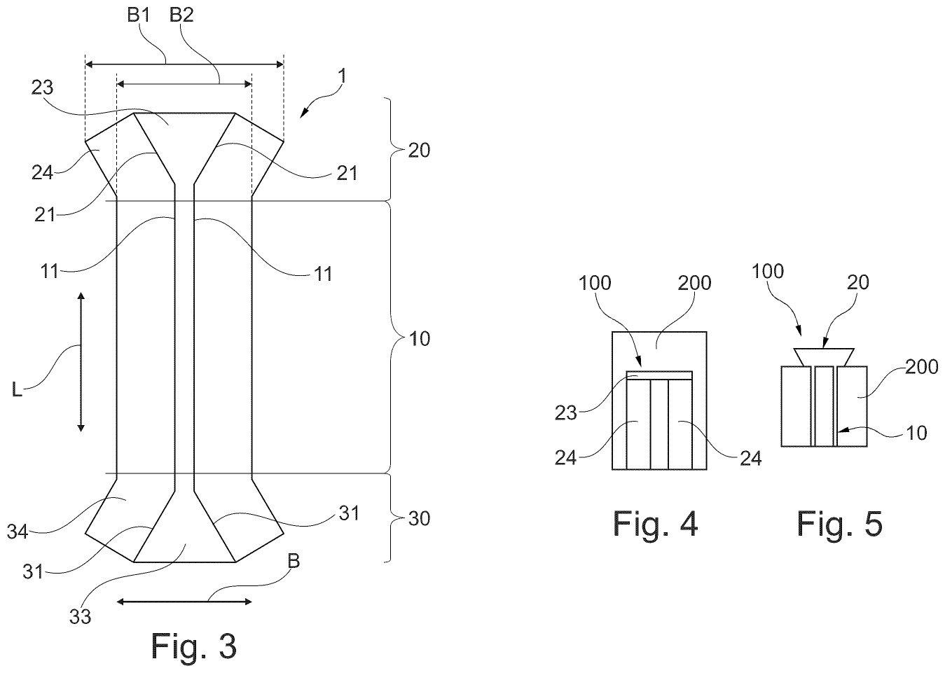

FIG. 3 shows a first embodiment of a semi-finished product 1 for producing a slot insulation element 100. The semi-finished product 1 consists of a flat, electrically insulating material, for example of paper, and has a rectangular slot section 10 adapted to be disposed in a slot of a stator 200 of an electrical machine. For this purpose, two fold lines 11 are provided in the slot section 10, which are disposed to run parallel to a longitudinal direction L of the semi-finished product 1. By folding along these fold lines 11, a U-shaped slot section of the slot insulation element 100 can be created, which can be disposed in the slot of the stator 200.

Adjacent to the slot section 10 of the semi-finished product 1, a first coil end section 20 is provided, which is disposed adjacent to the slot section 10 in the longitudinal direction L. The coil end section 20 is adapted to be disposed outside of the slot in the region of a coil end of the electrical machine and has a width B1 that is greater than a width B1 of the slot section 10. In this respect, the first coil end section 10 is formed with a greater width B1 than the slot section B2 in a width direction B perpendicular to the longitudinal direction L. On one side of the slot section 10, which is opposite the first coil end section 20 along the longitudinal direction L, a second coil end section 20 is disposed. The second coil end section 30 also adjoins the slot section 10 in the longitudinal direction L and is adapted to be disposed outside of the slot in the region of a coil end of the electrical machine. The second coil end section 30 has a greater width B2 than the slot section 10 in the width direction B. In this respect, the first and second coil end sections 20, 30 are formed with an identical shape.

In the first and second coil end sections 20, 30, fold lines 21, 31 are provided which adjoin the fold lines 11 of the slot section and are disposed to run obliquely to the longitudinal direction L. These fold lines 21, 31 separate a central portion 23, 33 of the respective coil end section 20, 30 from a side portion 24, 34 adjacent to the central portion 23, 33. By folding along the oblique fold lines 21, 31, a funnel-like shape with a U-shaped cross section of the slot insulation element 100 outside of the slot is created, see FIGS. 2, 4 and 5.

It can also be seen in FIG. 3 that the width B1 of the first and/or second coil end section 20, 30 increases to a point of maximum width starting from a transition to the slot section 10 along the longitudinal direction L and then decreases starting from the point of maximum width along the longitudinal direction L.

The representations in FIGS. 4 and 5 show a slot insulation element 100, which is made from a semi-finished product 1 according to FIG. 3 and is disposed in a slot of a stator 200.

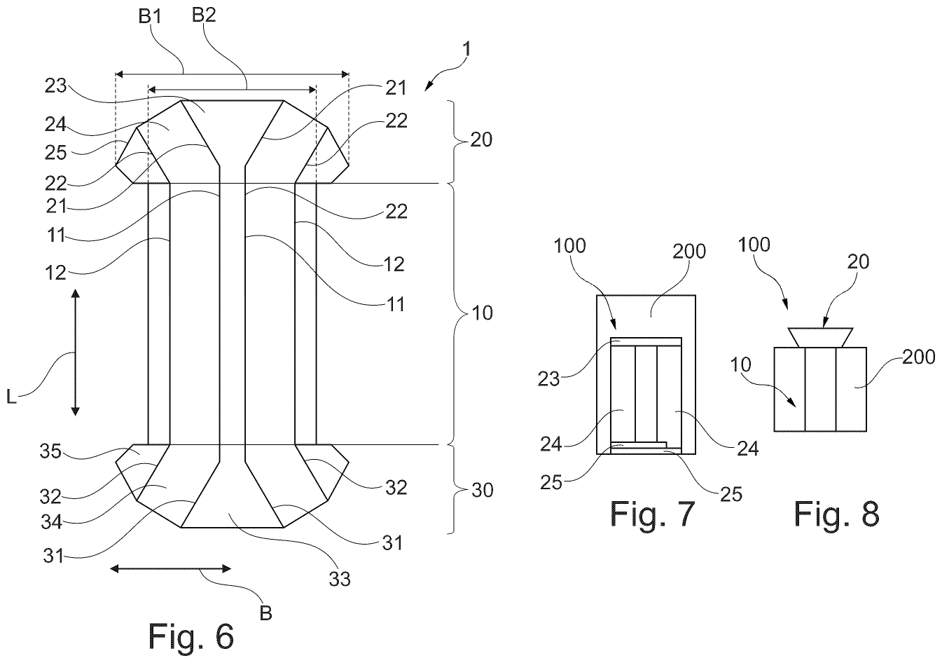

The representation in FIG. 6 shows a second exemplary embodiment of a semi-finished product 1 for producing a slot insulation element 100. This semi-finished product 1 is similar to the semi-finished product according to the first exemplary embodiment—elements with the same function are provided with identical reference numerals. Therefore, reference is made to the description of FIG. 3. In contrast to the first exemplary embodiment, in the second exemplary embodiment, outer fold lines 12, 22, 32 are provided which are disposed further outward with respect to a virtual central axis along the longitudinal direction L of the semi-finished product than the inner fold lines 11, 21, 32 explained in connection with FIG. 3. In the slot section 10, these outer fold lines 12 are disposed to be parallel to the inner fold lines 11 and parallel to the longitudinal direction L. By folding along these fold lines 11, 12, an O-shaped slot section of the slot insulation element 100 can be produced, in which the outer portions of the slot section are disposed in an overlapping manner.

The first and the second coil end section 20, 30 have two outer portions 25, 35 each adjacent to one of the side portions 24, 34. These outer portions 25, 35 are each separated from the respective side portion 24, 34 by an outer fold line 22, 32 disposed obliquely to the longitudinal direction L. The inner fold lines 21, 31 and the outer fold lines 22, 32 are disposed to be parallel.

The representations in FIGS. 7 and 8 show a slot insulation element 100, which is made from a semi-finished product 1 according to FIG. 6 and is disposed in a slot of a stator 200. It can be seen that the outer portions 25 of the semi-finished product 1 are disposed such that they overlap.

### LIST OF REFERENCE SIGNS

1 Blank
10 Slot section
20 Coil end section
21 Inner fold line
22 Outer fold line
23 Middle portion
24 Side portion
25 Outer portion
30 Coil end section
31 Inner fold line
32 Outer fold line
33 Middle portion
34 Side portion
35 Outer portion
100 Slot insulation element
200 Stator
201 Coil conductor
H1 Height of coil end
H2 Projection of the slot insulation element

1. A semi-finished product for producing a slot insulation element, wherein the semi-finished product is manufactured from a flat, electrically insulating material, comprising:
a rectangular slot section adapted to be disposed in a slot of a stator of an electrical machine, and
a first coil end section disposed in a longitudinal direction adjacent to the slot section and adapted to be disposed outside of the slot in a region of a coil end of the electrical machine,
wherein the first coil end section has a greater width than the slot section in a width direction perpendicular to the longitudinal direction.

2. The semi-finished product according to claim 1, further comprising a second coil end section disposed in the longitudinal direction adjacent to the slot section and adapted to be disposed outside of the slot in the region of a coil end of the electrical machine, wherein the second coil end section has a greater width than the slot section in a width direction perpendicular to the longitudinal direction and wherein the first and second coil end sections are disposed on opposite sides of the slot section.

3. The semi-finished product according to claim 1, wherein the first and/or second coil end section comprises fold lines disposed to run obliquely to the longitudinal direction.

4. The semi-finished product according to claim 1, wherein the first and/or second coil end section comprise a central portion and two side portions adjacent to the central portion, which are each separated from the central portion by an inner fold line disposed to run obliquely to the longitudinal direction.

5. The semi-finished product according to claim 4, wherein the first and/or second coil end section has two outer portions each adjacent to one of the side portions, which are each separated from the respective side portion by an outer fold line disposed to run obliquely to the longitudinal direction (L).

6. The semi-finished product according to claim 5, wherein the inner and outer fold lines are disposed to be parallel.

7. The semi-finished product according to claim 1, wherein the width of the first and/or second coil end section increases to a point of maximum width starting from a transition to the slot section along the longitudinal direction.

8. The semi-finished product according to claim 7, wherein the width of the first and/or second coil end section decreases starting from the point of maximum width along the longitudinal direction.

9. A slot insulation element for an electrical machine, wherein the slot insulation element is made from a semi-finished product, according to claim 5.

10. The slot insulation element according to claim 9, wherein the outer portions of the semi-finished product are disposed such that they overlap.

11. An electrical machine comprising a plurality of slots, wherein a slot insulation element according to claim 9 is disposed in each of the slots.
